(19) United States
(12) Patent Application Publication
(10) Pub. No.: US 2009/0085237 A1
(43) Pub. Date: Apr. 2, 2009

(54) METHOD AND APPARATUS FOR TENSIONING COVERSTOCK AND FORMING VEHICLE INTERIOR COMPONENTS

(75) Inventors: Chris WOLGAMOTT, Coopersville, MI (US); Michael VonHoltz, Holland, MI (US); Tom Dolce, Hudsonville, MI (US); Andrew Butz, Holland, MI (US); Richard P. Petkus, Hudsonville, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/863,986

(22) Filed: Sep. 28, 2007

(51) Int. Cl. B29C 45/80

(52) U.S. Cl. 264/40.5; 425/110

(57) ABSTRACT

A method of making a molded article using a coverstock and a substrate includes locating the coverstock between a first section of a mold and a second section of the mold. The method further includes causing relative movement between the first and second mold sections to bring the first and second mold sections closer together to shape the coverstock using a mold cavity formed by the second mold section and forming and tensioning the coverstock at least one of during and after the first and second mold sections are brought together. The tensioning includes at least any two of: (a) pressing the coverstock against a surface of the mold cavity in the second mold section using a rib structure extending from the first mold section, (b) holding at least a portion of the coverstock extending outside of the mold cavity at a constant location using at least a first retaining member extending from at least one of the first mold section and the second mold section, (c) pushing the coverstock toward the second mold section using a first pushing member disposed within the mold cavity, projecting from the first mold section, and coupled to a biasing member that biases the pushing member toward the second mold section, and (d) pressing the coverstock against an internal projection member extending from the second mold section using a thrust member projecting from and movable relative to the first mold section.

### BACKGROUND

The present invention relates generally to a method and apparatus for making a molded article and, more particularly, to a method and apparatus for making a molded article with a coverstock and substrate.

In the manufacture of products, such as vehicle doors, it is conventional to attach a coverstock to a substrate during a molding process to form a portion of the product. Molding such products continues to present challenges to those skilled in the art. Designing and providing tools for molding the products is also challenging. For example, the coverstock often must be transformed from an essentially flat or two-dimensional shape to a three-dimensional shape during the molding process. When being transformed in this manner, the coverstock can become wrinkled or lose surface markings (e.g., grain definition).

### SUMMARY

One embodiment of the invention relates to a method of making a molded article using a coverstock and a substrate. The method includes locating the coverstock between a first section of a mold and a second section of the mold. The method further includes causing relative movement between the first and second mold sections to bring the first and second mold sections closer together to shape the coverstock using a mold cavity formed by the second mold section and forming and tensioning the coverstock at least one of during and after the first and second mold sections are brought together. The tensioning includes at least any two of: (a) pressing the coverstock against a surface of the mold cavity in the second mold section using a rib structure extending from the first mold section, (b) holding at least a portion of the coverstock extending outside of the mold cavity at a constant location using at least a first retaining member extending from at least one of the first mold section and the second mold section, (c) pushing the coverstock toward the second mold section using a first pushing member disposed within the mold cavity, projecting from the first mold section, and coupled to a biasing member that biases the pushing member toward the second mold section, and (d) pressing the coverstock against an internal projection member extending from the second mold section using a thrust member projecting from and movable relative to the first mold section.

Another embodiment relates to an apparatus for making a molded article using a coverstock and a substrate. The apparatus comprises a mold having a first section and a second section, the second section having a surface for receiving a pressed A surface of the coverstock, the first section facing a B surface of the coverstock. The apparatus further comprising a first member extending from the first section, the first member configured to pinch the B surface of the coverstock when the mold is closed to force the A surface against the second section without damaging the A surface to inhibit resin injected between the B surface and the first section of the mold from flowing onto the A surface of the coverstock.

Yet another embodiment relates to an apparatus for making a molded article using a coverstock and a substrate. The apparatus includes a mold having a first section and a second section, the second section having a first surface for receiving a pressed A surface of the coverstock, the first section facing a B surface of the coverstock, wherein the mold further comprises tensioning structures. The tensioning structures include at least two of: (a) a rib structure extending from the first section or the second section, the rib structure configured to press the coverstock against a surface of the mold cavity, (b) a retaining member extending from the first section or the second section, the retaining member holding at least a portion of the coverstock extending outside of the mold cavity, (c) a pushing member disposed within the mold cavity, the pushing member projecting from the first section or the second section, the pushing member coupled to a biasing member configured to bias the pushing member toward the coverstock, (d) an internal projection member extending from the first surface of the second mold section, and a thrust member projecting from and movable relative to the first mold section.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of a vehicle according to an exemplary embodiment;

FIG. 2 is a perspective view of a portion of the interior of the vehicle of FIG. 1 including a trim panel according to an exemplary embodiment;

FIG. 3 is a section view of a trim panel, such as the panel shown in FIG. 2, according to an exemplary embodiment;

FIG. 4A is a side cutaway view of a mold for forming a molded article or trim panel according to an exemplary embodiment;

FIG. 4B is an elevation view of a full coverstock installed on retaining members of a mold section according to an exemplary embodiment;

FIG. 4C is an elevation view of a partial coverstock installed on retaining members of a mold section according to an exemplary embodiment;

FIG. 4D is a side cutaway view of a mold for forming a molded article or trim panel using a partial coverstock;

FIG. 5 is close-up side cutaway view of a mold for forming a molded article or trim panel according to an exemplary embodiment;

FIG. 6A is a top-down elevation view of a configuration of ribs according to an exemplary embodiment;

FIG. 6B is a perspective view of rib structure 65 shown in FIG. 6A according to an exemplary embodiment;

FIG. 6C is a schematic sectional view of a rib structure extending from a mold part according to an exemplary embodiment;

FIG. 7 is side cutaway view of a mold for use in a partial mold-behind application according to an exemplary embodiment;

FIG. 8 is a perspective view of two pin assemblies for tensioning coverstock according to an exemplary embodiment;

FIG. 9 is a flow chart of a process for tensioning coverstock according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

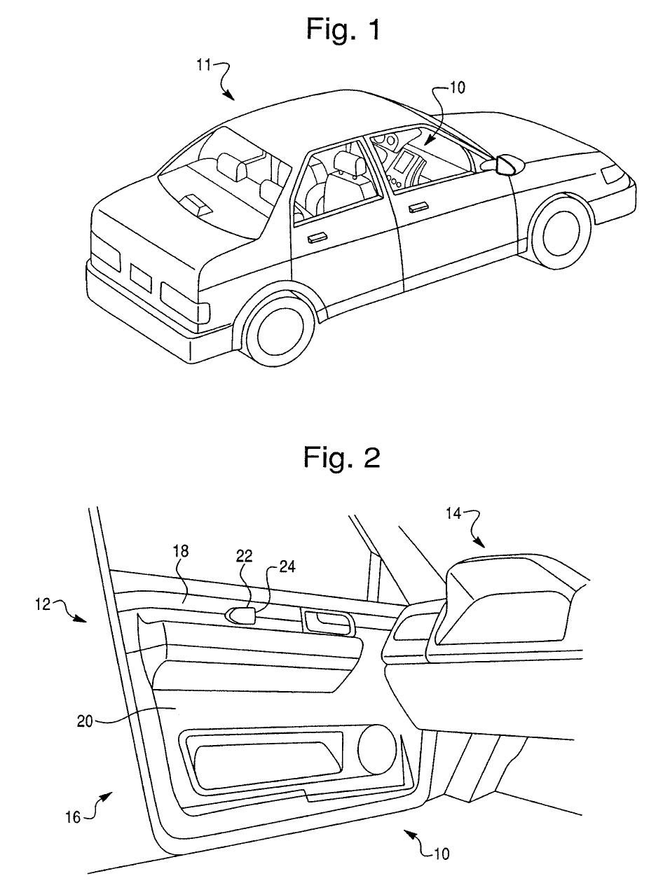

Referring to FIG. 1, a vehicle 11 is shown according to an exemplary embodiment. Vehicle 11 includes a vehicle interior 10 (e.g., a passenger compartment, etc.). While vehicle 11 is shown as an automobile, it should be understood that according to various alternative embodiments, vehicle 11 could be any of a wide variety of vehicles, including sport utility vehicles, vans, sports cars, sedans, buses, recreational vehicles, boats, airplanes, trucks, etc., and the teachings herein extend to all such applications.

FIG. 2 shows a perspective view of vehicle interior 10 in greater detail. Interior 10 is shown to include a door 12 and an instrument panel 14. Door 12 and instrument panel 14 each may comprise an outer trim compartment or panel 16 that is formed by a coverstock (e.g., a flexible member, skin, sheet, foil, etc. that forms an outer covering, all of which will be referred to as coverstock 18) coupled to a substrate (e.g., a rigid member, base, panel, etc., all of which will be referred to as substrate 20) for structural support. Trim panel 16 may also include element 22 coupled to coverstock 18 to provide a desired ornamental appearance and/or functional component. For the purposes of this disclosure, trim panel 16 could be coupled to instrument panel 14, or other surfaces within vehicle 11, or used in other applications where a trim panel is desired (e.g., in applications not involving a vehicle such as a vehicle 11). For example, trim panel 16 (and the methods, apparatuses, and systems described herein for forming trim panels) could be any suitable vehicle interior component or molded article of any type, including (but not limited to): instrument panels (or components thereof); overhead consoles; floor consoles; center consoles; seats; pillar trim; headliners; cargo systems; map pockets; door bolsters; door beltlines; etc.

According to one embodiment, substrate 20 provides the substantial, if not the entire, structural support for trim panel 16 generally, and may provide structural support to various components that are attached to trim panel 16 (e.g., armrests, speakers, handles, etc.). Substrate 20 may further provide an ornamental or decorative appearance. According to an exemplary embodiment, substrate 20 is a rigid structure. It can be formed, for example, by injection molding a polymer resin in a process that uses heat and pressure to inject a molten resin into a cavity formed in a mold tool. Substrate 20 may be made from a variety of suitable materials. For example, injection molded polypropylene is one method and material for making substrate 20, but other materials can be used, including other thermoplastic resins such as polyethylene, acrylonitrile butadiene styrene (“ABS”), polyurethane nylon, any of a variety of homopolymer plastics, copolymer plastics, plastics with special additives, filled plastics, etc. Also, other molding operations may be used to form these components, such as injection compression molding, etc.

Coverstock 18 may provide an ornamental or decorative appearance to trim panel 16 using different materials, textures, colors, treatments, secondary operations (e.g., sewing), or the like. According to exemplary embodiments, a substantial portion of one side of coverstock 18 serves as part of the outer covering of trim panel 16. Coverstock 18 may also provide a functional feature to trim panel 16, such as a soft or cushioned portion or region of trim panel 16 (e.g., a softer portion of trim panel 16 relative to substrate 20), a raised portion of trim panel 16, a different surface compared to substrate 20, or the like. According to an exemplary embodiment, coverstock 18 comprises a plurality of layers to form a laminate. According to an exemplary embodiment, coverstock 18 comprises a foam layer between two polymer layers. Alternatively, coverstock 18 may be formed by a single layer. Coverstock 18 may be a single, unitarily formed, integral sheet, or a plurality of sections (e.g., layers, patches, bilaminate, trilaminate, etc.) coupled together (e.g., sewn, fastened, bonded, etc.). Coverstock 18 may be manufactured from a sheet of material (e.g., in flat sheets, or rolls, etc.). According to an exemplary embodiment, coverstock 18 is made from a laminate of a vinyl layer, a polypropylene foam layer, and a polypropylene layer, but can be made from any of a variety of materials and compositions including fabric, cloth, natural material, textile (e.g., woven, non-woven, knit, etc.), polymer (e.g., thermoplastic elastomer polyolefin (TPO), materials formed by reaction injection molding (RIM), etc.), elastomer, or the like or combinations thereof; and may have multiple layers (e.g., outer, inner, scrim, etc.). Further, the coverstock may be a preformed or not and may be or include any suitable material (e.g., thermoplastic urethane (TPU), thermoplastic elastomer (TPE), cross-linked TPO, a coextruded compact sheet, a bilaminate composite, a trilaminate composite, a thin film applique (e.g., plastic, wood, metal, fibrous, etc.), a carpet composite (e.g., with or without a foam and/or scrim), a leather or imitation leather/suede composite (e.g., with or without a foam and/or scrim), expanded PVC, or supported and expanded PVC.

Coverstock 18 can have an A surface and a B surface. As used herein, the term A surface refers to the surface of the coverstock 18 that typically is visible (e.g., to an occupant) when trim panel 16 is mounted in vehicle interior 10. As used herein, the term B surface refers to the surface of coverstock 18 that typically faces or is coupled to substrate 20.

Element 22 can be coupled to coverstock 18 and generally refers to a film, sheet, or the like that according to one embodiment provides a decorative effect, a function, and/or structural support to another component.

Coverstock 18 and substrate 20 may be formed with a groove 24 (e.g., a ditch, indentation, notch, perforation, etc.). Groove 24 may accept an element 22, as shown in FIG. 2. Element 22 may be partially or entirely disposed or located in a recess 21 (e.g., pocket, indent, indentation, etc.) in coverstock 18 so that the element 22 is substantially flush (e.g., coplanar, etc.) or recessed from the surface of coverstock 18. Alternatively, recess 21 may be more shallow so that element 22 protrudes past the surface of coverstock 18. Groove 24 may also serve as the boundary or seam (aesthetically pleasing or not) between coverstock 18 and substrate 20.

According to one embodiment, element 22 may comprise a decorative layer coupled to a backing layer such as a decorated acrylic top layer and a acrylonitrile butadiene styrene (“ABS”) or thermoplastic elastomer polyolefin (TPO) backing layer. Alternatively, element 22 may be formed of aluminum or other decorative materials such as wood laminates and may be attached and/or in-molded using the processes described herein. According to an exemplary embodiment, element 22 is made from flexible and/or compressible materials. According to alternative embodiments, element 22 may be any of a variety of flexible or rigid members intended for disposition on the A surface of coverstock 18.

According to an exemplary embodiment, element 22 may be coupled to coverstock 18 by an adhesive, but may also (or alternatively) be coupled to coverstock 18 via a connector. The connector may be inserted into a perforation 29 in coverstock 18 and/or substrate 20 and held in place by any number of interfaces, methods, or devices.

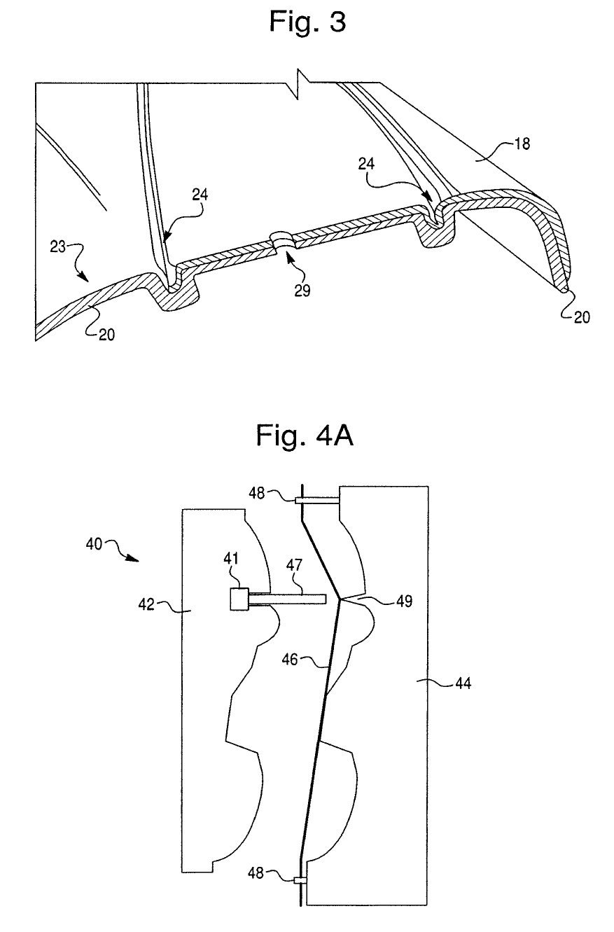

Referring now to FIG. 3, a section view of a trim panel, such as the trim panel shown in FIG. 2, is shown according to an exemplary embodiment. FIGS. 2 and 3 show the product of a partial mold-behind process whereby only a portion of the trim panel is covered by coverstock 18 and a part of the substrate 20 is left exposed (e.g., exposed surface 23 shown in FIG. 3). Groove or ditch 24 may serve as a boundary or seam between the A surface of coverstock 18 and the A surface or exposed surface 23 of substrate 20. It is important to note that the molds, methods, apparatuses, and/or systems disclosed herein may be used with a full mold-behind process, a partial mold-behind process, an injection-compression process, a closed-mold process, and/or any other compatible process. One or more perforations (e.g., holes, punctures, cutouts, etc.) 29 may be made in coverstock 18. Perforations 29 may be used for coupling coverstock 18 to other components, structures, support elements, decorative elements, functional elements, and the like.

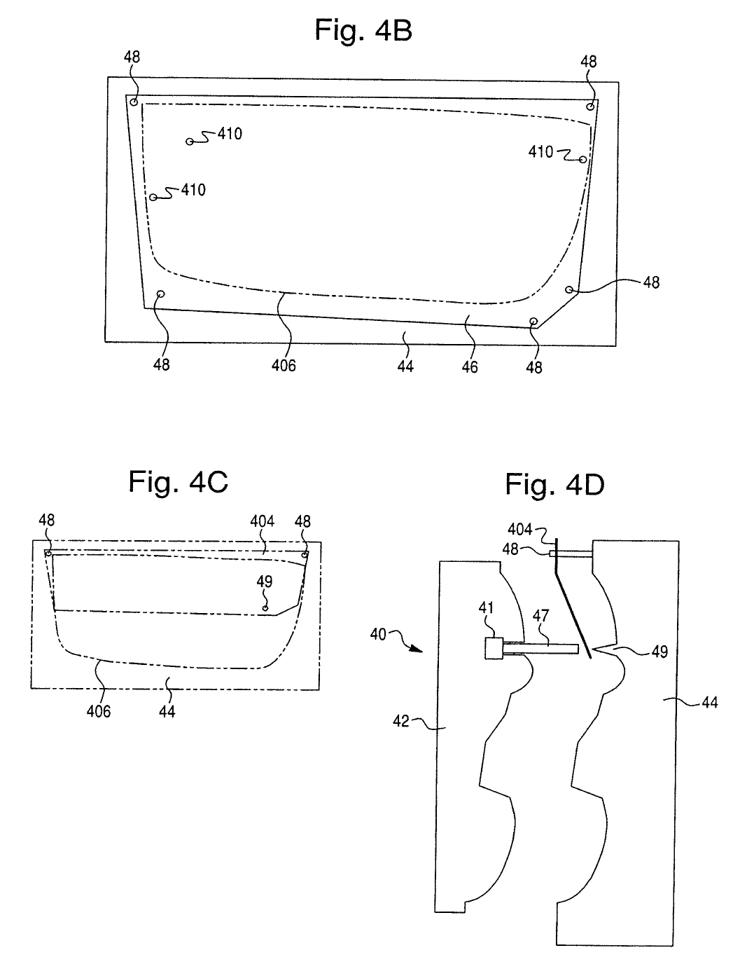

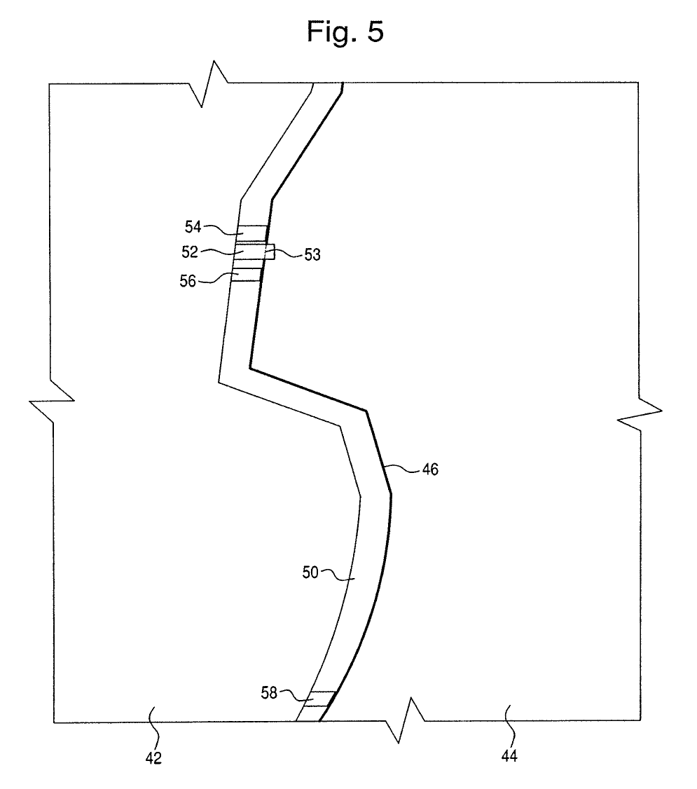

Referring now to FIG. 4A, a cross-sectional schematic view of a coverstock within a mold is shown for a full mold-behind process, according to an exemplary embodiment. FIG. 4A shows a mold 40 having a first mold section 42 and a second mold section 44. Mold 40 closes (or partially closes) around coverstock 46 (e.g., by moving mold sections 42 and 44 toward each other or one of the sections 42, 44 towards the other section) so that a relatively narrow gap 50 (e.g., a cavity, space, etc.) is provided between mold section 42 and mold section 44 (see FIG. 5).

FIG. 4B is an elevation view of coverstock 46 positioned on second mold section 44. As shown, coverstock 46 extends through the entirety of the mold. Retaining members 48 and 410 (e.g., pins) are connected to coverstock 46 to create tension in and around the coverstock. Retaining members 48 and 410 may extend through holes or perforations in coverstock 46, may be effectively coupled to coverstock via sharp point on the retaining members, or otherwise. Retaining members 48 and 410 may be stationary or movable. In addition to a sharp pin point, the retaining members may have a blunt nose, a bullet nose, or any other suitable surface or shape. Retaining members 48 and 410 may be provided in any diameter and quantity (e.g., coverstock 46 may be coupled to mold section 44 via one retaining member, two retaining members, or more). A portion of mold section 44 and coverstock 46 may extend beyond the perimeter of the usable core or cavity of the mold section. The dotted line shown in FIG. 4B represents the usable mold cavity 406 of mold section 44. In a case such as that shown in FIG. 4B, where a portion of the mold section and coverstock extend beyond the usable core or cavity, extra material (“offal”) may be present and it may be possible to couple coverstock 46 to mold section 44 via retaining members 48 located outside mold cavity 406 and coupled to the offal. Tensioning retaining members 410 (e.g., pins) may also (or alternatively, particularly if enough offal is not available) be provided on the inside of usable core or cavity 406. A side cutaway view of retaining members are also shown in FIG. 4A.

Referring to FIGS. 4C and 4D, views of a mold and coverstock configured for a partial mold-behind process are shown. Coverstock 404 only extends partially into mold cavity 406 and may be used to create the trim panel shown in FIGS. 2 and 3 or otherwise.

To further describe the molding process, reference will now be made to FIG. 5, which illustrates the steps in the full mold-behind process shown in FIGS. 4A and 4B. It is recognized, however, that similar steps could be employed in the partial mold-behind process shown in FIGS. 4C and 4D. In FIG. 5, molten polymer resin may be injected into gap 50 between core 42 and coverstock 46, 404 to form the substrate 20. As molten plastic resin fills gap 50, coverstock 46, 404 is pressed against mold section 44. After the plastic resin has sufficiently solidified, a trim panel now including coverstock 46, 404 and substrate may be removed from mold 40. After the plastic resin forms into a sufficiently solidified substrate, the trim panel can undergo any of a variety of finishing operations (e.g., removing any portions of coverstock 46 not attached to substrate, wrapping the portions around and coupling to the B surface of the substrate, etc.). Trim panels may also have a variety of decorative or functional elements attached thereto.

As coverstock is provided to a mold, it may be important to create tension around the perimeter and/or interior of the coverstock. Coupling coverstock 46, 404 to the mold 40 under tension can provide a more aesthetically pleasing trim panel. This may particularly be true when the coverstock is in sheet form or some other intermediate form. Inadequate tension (or uneven tension within the mold) may cause wrinkles as the coverstock transforms from a flat sheet (or other intermediate form) into a three dimensional shape and as the molten plastic resin fills gap 50 and presses coverstock 46, 404 against mold section 44.

Applicants have found that tensioning the coverstock using a combination of methods can be particularly effective. Four methods of tensioning the coverstock are described herein. It has been determined that an unexpected decrease in wrinkling and grain deterioration of the coverstock 46, 404 occurs when at least two of these tensioning methods are used together.

One method of tensioning the coverstock is shown in FIGS. 4A, 4B, 4C, and 4D. According to an exemplary embodiment, coverstock 46, 404 is mounted under tension in mold section 44 by retaining members or projections 48 (e.g., pins) extending from mold section 44. According to an exemplary embodiment, projections 48 are pointed projections that may puncture or pinch coverstock 46, 404. According to yet other exemplary embodiments, projections 48 are prismatic, cylindrical, rectangular, or any other suitable shape and extend through a perforation and/or pre-cut hole formed in coverstock 46, 404. Coverstock 46, 404 may also (or alternatively) be suspended (e.g., hung) from projections 48. Coverstock 46, 404 may also (or alternatively) be placed in mold 40 using a variety of techniques including robotic placement, manual placement, a vacuum device, using adhesive or the like, and/or may be held in place by its shape registering with the shape of mold 40, etc.

Another method of tensioning the coverstock also is shown in FIGS. 4A and 4D, as well as being shown and described in U.S. Pat. No. 6,673,296, issued Jan. 6, 2004, the entirety of which is hereby incorporated by reference. In this method, an internal projection 49 can extend from mold half 44 and is located across from a corresponding recess in the other mold half 42. The coverstock 46, 404 is positioned between the mold halves 42, 44 and over internal projection 49. A thrust member 47 is assembled within the other mold half 42 and projects toward internal projection 49 so that a distal end of thrust member 47 retains coverstock 46, 404 on internal projection 49. The distal end of thrust member 47 may remain positioned (during and after the clamping of the mold halves 42, 44) so that coverstock 46, 404 is positioned (e.g., and tensioned) on internal projection 49. Resin may then be injected into a space between the mold halves to form a substrate on one side of coverstock 46, 404. Thrust member 47 may be retracted by the resin injected into the space between the mold halves. Movement actuator 41 (e.g., a pneumatic cylinder, etc.) is configured to move thrust member 47 during the forwarding and retracting steps. The movement of thrust member 47 may occur independently of any movement of mold half 42. When thrust member 47 is forwarded toward internal projection 49, movement actuator 41 causes/controls the movement of thrust member 47. Therefore, forwarding thrust member 47 toward internal projection 49 (so that thrust member 47 retains coverstock 46 on internal projection 49) may occur and provide tension to coverstock 46 regardless of whether mold halves 42, 44 are closed or closing.

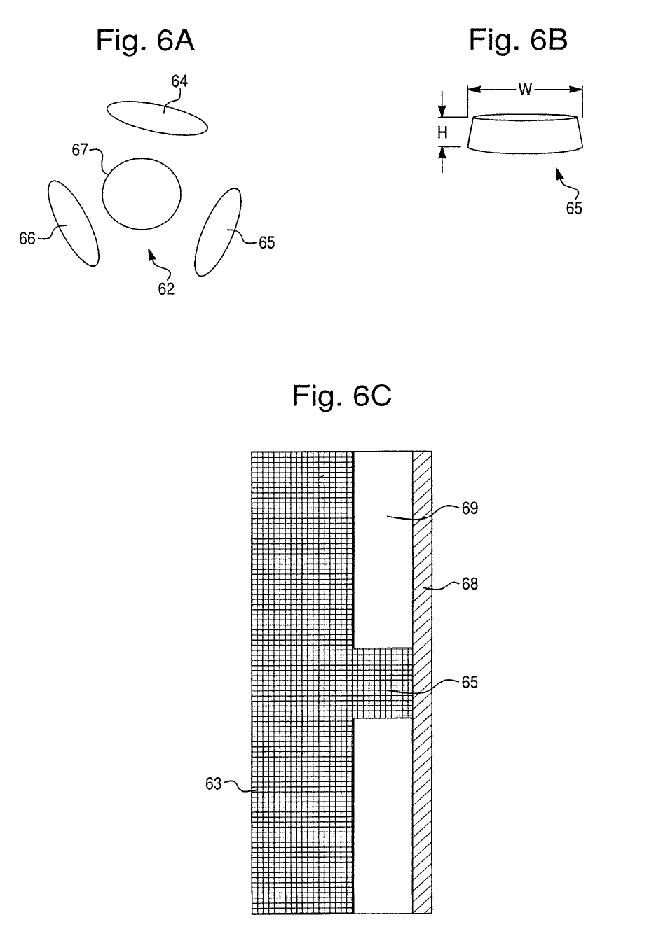

A third tensioning method is shown in FIGS. 5-6C. According to an exemplary embodiment, the members (e.g., configuration of ribs) may be used to tension coverstock as its A surface is pressed against a surface of the mold to be shaped. This tensioning method is particularly useful when a perforation has been made in coverstock 46.

When a perforation is to be made in or on coverstock 46, a blade 52 may extend from mold section 42, section 44, or another part or member of the mold system. Blade 52 may perforate or cut coverstock 46 to create a perforation 53 when the mold is closed. A perforation or hole in coverstock 46 may be made in other ways (e.g., made prior to insertion onto or into mold 40).

Once the perforation is created and resin is injected into gap 50 between core 42 and coverstock 46, the resin may sometimes flow into the perforation and over the top of coverstock 46 (“spillage”). When spillage occurs in a visible area on the coverstock, the part is typically not acceptable and is either reworked or rejected during a quality control process.

Referring again to FIG. 5, members 54 and 56 are provided that extend from core 42. Members 54, 56 (i.e., rib structures) press against the backside of coverstock 46 (i.e., the B surface) and force the A surface of coverstock 46 against the mold section. According to an exemplary embodiment, members 54 and 56 are configured to press against the coverstock with enough force to “pinch off” on the backside of the coverstock so that polymer may not flow over the top of coverstock 46 (e.g., onto the A surface, which is typically the show surface). Multiple members 54, 56 may be provided to an area (e.g., the area surrounding blade 52 or perforation 53). Alternatively, only one member may be provided to any area, mold, or around a perforation or blade. The members may be placed on the ejector half of a mold (i.e., the half of the mold from which resin is ejected, the half of the mold facing the backside or B surface of coverstock 46)(e.g., core 42). Members 54, 56 may be shaped or formed as ribs (e.g., arches, curved beams, oval shaped, etc.). Referring still to FIG. 5, rib 58 may be provided for holding coverstock 46 against mold part 44 without being near or around a perforation.

Referring now to FIG. 6A, an elevation view of another configuration of ribs (i.e., members) 62 is shown. Configuration of ribs 62 includes ribs 64, 65, and 66. Configuration of ribs 62 may surround or otherwise be adjacent to perforation 67. Ribs 64-66 may be spaced equidistant or roughly equidistant from perforation 67. As shown, the top of ribs 64-66 are generally elongated and/or oval-shaped. Referring also to FIG. 6B, a perspective view of rib 65 is shown. Rib 65 may have a height H of approximately 3 mm, but shorter or taller ribs may be provided. According to an exemplary embodiment, ribs 65 are between 1.5 mm and 6 mm in height. According to yet other exemplary embodiments, ribs 65 extend from a surface of the ejector half of a mold and are tall enough so that they pinch the coverstock against the A surface of the mold (i.e., the mold section opposite the ejector half). Referring to FIG. 6C, a cutaway view of rib 65 as it may operate against coverstock 68 is shown. Rib 65 extends from mold section 63 (e.g., ejector half) into gap 69 so that the end of rib 65 exerts force on coverstock 69.

Ribs 64, 65, and 66 may be attached to an already-made mold section (e.g., via welding, adhesives, etc.) or may be machined as a part of a mold section (e.g., the ejector block). According to an exemplary embodiment, the rib shapes are included in the original tool design and fabricated from an original parent ejector block. Rib location (or configuration of ribs location) is optimized by analyzing the coverstock design and estimating or otherwise analyzing the polymer flow.

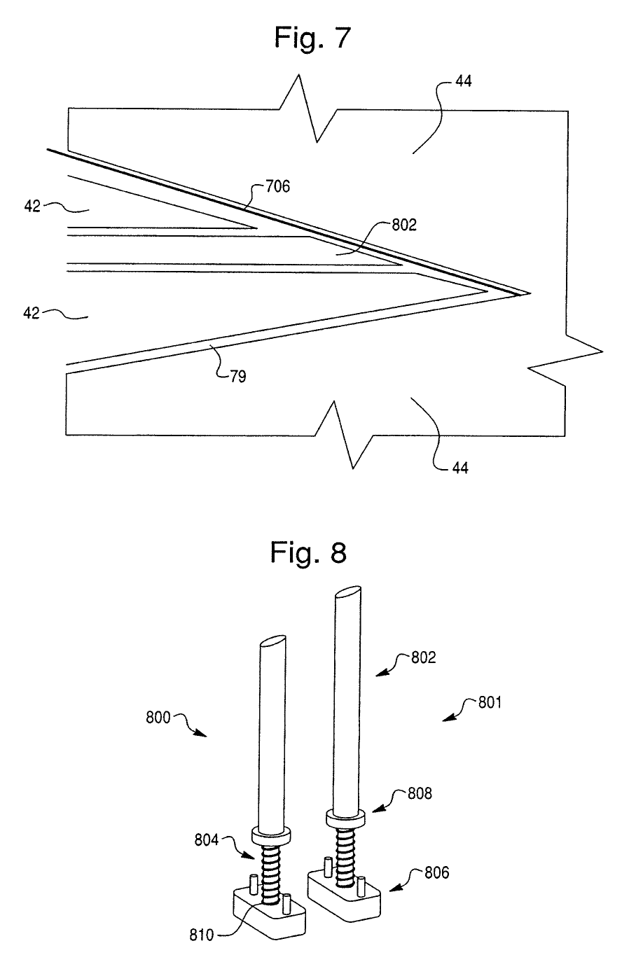

A fourth tensioning method is disclosed in FIGS. 7 and 8. FIG. 8 is a perspective view of assemblies 800 and 801 according to an exemplary embodiment. The pin assemblies of FIG. 8 are shown and described in U.S. Provisional Application Ser. No. 60/929,934, filed Jul. 17, 2007, the entirety of which is hereby incorporated by reference. One or more pin assemblies 800, 801 may be provided in a molding tool (e.g., a molding tool half or section 42) to hold coverstock 706 against molding surface (e.g., the A surface) or mold section 44 that directly forms or molds the coverstock. According to an exemplary embodiment, one or more pushing members 802 (e.g., pins) may be movably connected to first mold section 42 to extend toward, or retract from, second mold section 44. Pushing members 802 help conform coverstock 706 to the contour of the molding surface of mold section 44 so that the coverstock is tensioned and the chance of winkles that may form in the coverstock as the polymer material is injected into the gap behind the coverstock is reduced. Referring further to FIG. 8, each assembly includes a pushing member 802 (e.g., a pin), a biasing element 804 (shown as a coil spring), a retainer plate 806, an auxiliary plate 808 coupled to the ejector pin, and one or more coupling members 810 (e.g., shown as bolts).

FIG. 7 illustrates pushing member 802 configured to form and tension coverstock 706 although coverstock 706 is not a sheet that extends outside of the mold cavity on all sides (FIG. 7 shows a partial mold-behind process). Coverstock 706 is shown placed into a groove, ditch, or projection in the mold. Without appropriate tensioning near the edge of coverstock, the coverstock may not be placed into the ditch properly (or may slip out of the ditch when other areas of the coverstock experience tension). Any of the four tensioning methods herein disclosed may provide the tensioning necessary to place and retain the edge of the coverstock into a ditch, groove, or projection properly (even when partial mold-behind processes are used). However, Applicants have found that tensioning the coverstock using a combination of methods can be particularly effective to solve wrinkling, coverstock edge placement, and grain washout problems/issues in the context of partial mold-behind processes.

It is important to note that any of the four above-described methods of tensioning may be provided to or extend from either section of a mold. In some cases it may be desirable to alternate the section to which each different type of tensioning method is provided. In other cases, tensioning methods of the same type may be provided to different sections.

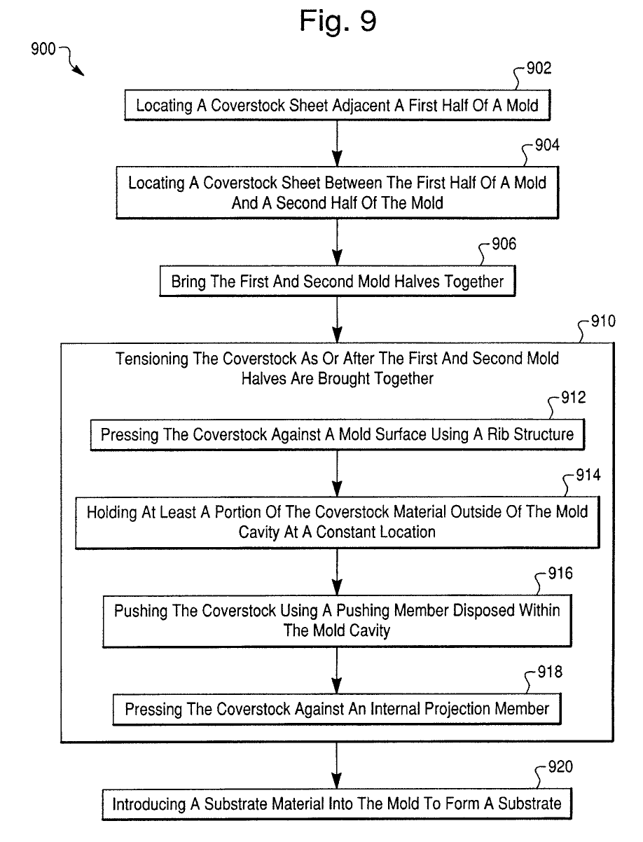

Referring to FIG. 9, a process 900 of tensioning coverstock is shown, according to an exemplary embodiment. Process 900 may include locating a coverstock adjacent a first half of a mold (step 902). According to a preferred embodiment, the first half of the mold is the mold that will directly interface with the A surface of the coverstock. Process 900 may further include locating the coverstock between the first half of the mold and a second half of the mold (step 904) According to a preferred embodiment, the second half of the mold is the half that directly interfaces with the substrate when it is introduced into a gap between the second half of the mold and the B surface of the substrate. Process 900 further includes bringing the first and second mold sections together (step 906). As the first and second mold sections are brought together in step 906, or also before and/or after, the coverstock may be tensioned (step 910). Sufficient tensioning may be provided to reduce the probability of the coverstock wrinkling during the closing of the mold (e.g., step 906). Tensioning (step 910) may be provided in the injection-compression context (i.e., some substrate is injected before/while a mold is closing, the injection completing when the mold is closed), in the closed mold context (substrate is injected after the mold is closed), or otherwise.

Tensioning the coverstock may include any one of: pressing the coverstock against a mold surface using a rib structure (step 912)(e.g., the rib structures shown in FIGS. 5-6C); holding at least a portion of the coverstock material outside of the mold cavity at a constant location (step 914)(e.g., using the retaining members shown in FIGS. 4A-4D); pushing the coverstock using a pushing member disposed within the mold cavity (step 916)(e.g., pushing member 802 shown in FIGS. 7 and 8); pressing the coverstock against an internal projection member using a thrust member (step 918)(e.g., using a structure or process described in U.S. Pat. No. 6,673,296, etc.). Process 900 may also include introducing the substrate into the mold to form a substrate behind the coverstock (step 920).

According to any preferred embodiment, tensioning the coverstock as the first and second mold sections are brought together (e.g., step 910 of FIG. 9) includes a combination of steps 912 through 918. It has been determined that providing a combination of two or more tensioning types to coverstock is more effective at reducing wrinkles in coverstock and reducing grain deterioration.

It is to be understood that the invention is not limited to the details of construction and arrangement of the components set forth in the foregoing description or illustrated in the drawings. The invention is capable of other embodiments or being practiced or carried out in various ways. The molded article or trim panel described in this disclosure may be employed in a variety of applications. It is also to be understood that the phraseology and terminology employed herein is for the purpose of description and should not be regarded as limiting. For example, the terms “substrate,” “coverstock,” and “decorative element” are intended to be broad terms and not terms of limitation. These components (or other components herein disclosed) may be used with any of a variety of products or arrangements and are not intended to be limited to use with automotive applications.

It is also important to note that the construction and arrangement of the elements of the method of tensioning coverstock as shown and described in the exemplary embodiments is illustrative only. Although only a few embodiments of the present application are described in detail in this disclosure, those skilled in the art who review this disclosure will readily appreciate that many modifications are possible (e.g., variations in size, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed and/or otherwise varied, the length or width of the structures and/or members or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and/or combinations. Accordingly, all such modifications are intended to be included within the scope of the present inventions. Other substitutions, modifications, changes and omissions may be made in the design, operating conditions and arrangement of the exemplary embodiments without departing from the spirit of the present invention.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments. Also, two or more steps may be performed concurrently or with partial concurrence.

What is claimed is:

1. A method of making a molded article using a coverstock and a substrate, the method comprising:
locating the coverstock between a first section of a mold and a second section of the mold;
causing relative movement between the first and second mold sections to bring the first and second mold sections closer together to shape the coverstock using a mold cavity formed by the second mold section; and
forming and tensioning the coverstock at least one of during and after the first and second mold sections are brought together, the tensioning comprising at least any two of:
(a) pressing the coverstock against a surface of the mold cavity in the second mold section using a rib structure extending from the first mold section,
(b) holding at least a portion of the coverstock extending outside of the mold cavity at a constant location using at least a first retaining member extending from at least one of the first mold section and the second mold section,
(c) pushing the coverstock toward the second mold section using a first pushing member disposed within the mold cavity, projecting from the first mold section, and coupled to a biasing member that biases the pushing member toward the second mold section, and
(d) pressing the coverstock against an internal projection member extending from the second mold section using a thrust member projecting from and movable relative to the first mold section.

2. The method of claim 1, wherein the step of holding at least a portion of the coverstock extending outside of the mold cavity includes inserting the first retaining member into a perforation in the coverstock.

3. The method of claim 1, further comprising:
introducing a substrate into a gap between the first and second mold sections to form a substrate coupled to the coverstock.

4. The method of claim 3, further comprising:
forming a perforation in the coverstock;
wherein the step of pressing the coverstock against a surface of the mold cavity in the second mold section using a rib structure further comprises:
pressing the rib structure at a location such that the substrate is not allowed to flow through the perforation.

5. The method of claim 4, further comprising:
providing at least two additional rib structures;
pressing the at least two additional rib structures at locations surrounding the perforation.

6. The method of claim 5, further comprising:
analyzing a coverstock design and an expected flow of the substrate;
installing or adjusting the rib structure based on the analyzing.

7. The method of claim 5, wherein the rib structure and the at least two additional rib structures are integrally formed from the first section of the mold.

8. An apparatus for making a molded article using a coverstock and a substrate, the apparatus comprising:
a mold having a first section and a second section, the second section having a surface for receiving a pressed A surface of the coverstock, the first section facing a B surface of the coverstock; and
a first member extending from the first section, the first member configured to pinch the B surface of the coverstock when the mold is closed to force the A surface against the second section without damaging the A surface to inhibit resin injected between the B surface and the first section of the mold from flowing onto the A surface of the coverstock.

9. The apparatus of claim 8, further comprising:
a second member extending from the first section, the second member located so that a perforation in the coverstock is disposed between the first and second member when the mold is closed.

10. The apparatus of claim 8, further comprising:
a second and third member extending from the first section, the first, second, and third members surrounding a perforation in the coverstock when the mold is closed.

11. The apparatus of claim 10, wherein the first, second, and third members are configured to pinch the B surface of the coverstock when the mold is closed to force the A surface against the second section without damaging the A surface to inhibit resin injected between the B surface and the first section of the mold from flowing onto the A surface of the coverstock.

12. The apparatus of claim 8, wherein the first member is between about 1.5 mm and 6 mm tall.

13. The apparatus of claim 10, wherein the first, second, and third members are formed from a same type of material as the first section, and wherein the first, second, and third members are integrally formed with the first section.

14. The apparatus of claim 8, wherein the first member is configured to hold the coverstock in place while the mold is closing, the coverstock being partially preformed.

15. The apparatus of claim 8, wherein the first member is configured to provide tension to the coverstock as the mold is closing to inhibit wrinkling of the coverstock.

16. The apparatus of claim 15, further comprising:
a retaining member configured to provide tension to the coverstock while the mold is closing, the retaining member extending from the second section and coupling to offal of the coverstock.

17. The apparatus of claim 15, further comprising:
a first pushing member disposed within the mold cavity, projecting from the first member, and coupled to a biasing member that biases the first pushing member toward the second member to push the coverstock toward the second member.

18. The apparatus of claim 15, further comprising:
an internal projection member extending from the second section;
a movable thrust member extending from the first section, the thrust member being configured to press the coverstock against the internal projection member so that tensioning is provided to the coverstock.

19. An apparatus for making a molded article using a coverstock and a substrate, the apparatus comprising:
a mold having a first section and a second section, the second section having a first surface for receiving a pressed A surface of the coverstock, the first section facing a B surface of the coverstock, wherein the mold further comprises tensioning structures, the tensioning structures including at least two of:
(a) a rib structure extending from the first section or the second section, the rib structure configured to press the coverstock against a surface of the mold cavity,
(b) a retaining member extending from the first section or the second section, the retaining member holding at least a portion of the coverstock extending outside of the mold cavity,
(c) a pushing member disposed within the mold cavity, the pushing member projecting from the first section or the second section, the pushing member coupled to a biasing member configured to bias the pushing member toward the coverstock,
(d) an internal projection member extending from the first surface of the second mold section, and a thrust member projecting from and movable relative to the first mold section.

20. The apparatus of claim 19, wherein the tensioning structures are configured to provide tension to the coverstock as the mold is closing or closed, to inhibit wrinkling of the coverstock.
